(19) United States
(12) Patent Application Publication
(10) Pub. No.: US 2011/0320433 A1
(43) Pub. Date: Dec. 29, 2011

(54) Automated Joining of Disparate Data for Database Queries

(75) Inventors: Imran Mohiuddin, Redmond, WA (US); Mahmood Gulam Qadir, Redmond, WA (US); Yi Miao, Bellevue, WA (US); Bryan Jason Dove, Seattle, WA (US); Jonathan Alan Handler, Northbrook, IL (US); Craig F. Feied, Kirkland, WA (US); Mehul Y. Shah, Redmond, WA (US)

(73) Assignee: MICROSOFT CORPORATION, Redmond, WA (US)

(21) Appl. No.: 12/823,145

(22) Filed: Jun. 25, 2010

(51) Int. Cl. G06F 17/30

(52) U.S. Cl. 707/714; 707/E17.054

(57) ABSTRACT

Described is associating metadata with different sources of data (e.g., database tables) that allows a single view of data from the sources to be created. An administrator creates baseviews corresponding to database tables and associates metadata with the baseviews, including primary key metadata for the baseviews and meta-tags for one or more of the columns of each baseview. A user selects fields (corresponding to table columns) from a starting baseview, along with fields from any other baseview that has metadata that matches the starting baseview's metadata. A join mechanism automatically creates the view if a metadata match is detected.

### BACKGROUND

One of the challenges with allowing users to arbitrarily request data elements from a database is the ability to present different elements in a related fashion. For example, consider Microsoft Amalga™ UIS, a unified intelligence system/service that provides client users with access to clinical and other patient-related data. If a client user wants to view data about a medical procedure that was done on a patient in conjunction with that patient's financial data, e.g., whether the insurance company paid and when, the only way to do this is through a system administrator or the like creating such a custom view. This is because in general, such disparate information is maintained in different tables, each table having its own corresponding baseview, and a user can only create a userview based on a single baseview.

What is desirable is for users to be able to use all available stored data of such a system/service to create views and/or identify answers to questions, without needing the assistance of system administrative support, including manual administrator efforts to create and manage custom views for individual users. It is also desirable for users to be able to gather and collect relevant data in a generally automated fashion and share such data.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which data from different (e.g., disparate) data sources may be joined via metadata to create a single view (userview) of the data from the sources. In one aspect, an administrator or the like creates baseviews corresponding to database tables and associates metadata with the baseviews, including primary key metadata for the baseviews and meta-tags for one or more of the columns of each baseview. A user selects fields (corresponding to table columns) from a starting (recipient) baseview, along with fields from any other (donor) baseview that has metadata that matches the recipient baseview's metadata.

In one implementation, a join mechanism comprising join logic evaluates the metadata to determine if a join may be automatically created to provide the desired userview. If not, the join mechanism may provide the user with suggestions of fields that may be joined to facilitate manual selection of a field. The join mechanism may allow the user to override automatic joining and/or manually select another field to join.

In one aspect, a user interface is provided to assist the user in selecting fields and adding them to the userview. Once created, the userview may be saved, e.g., in a library, for re-use and/or sharing.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a representation of a system by which an administrator or process associates database tables with metadata by which a user may join columns from those tables to create a custom view.

FIGS. 2-4 comprise a flow diagram representing operations in the system of FIG. 1, including user interaction (FIG. 2) with the system, join logic (FIG. 3) and administrator/process interaction (FIG. 4).

FIG. 5 is a representation of a user interface screen by which a user may select fields (columns) from baseviews of different tables to create a desired inter-table view.

FIG. 6 shows an illustrative example of a computing environment into which various aspects of the present invention may be incorporated.

### DETAILED DESCRIPTION

Various aspects of the technology described herein are generally directed towards inferring rules on relating disparate data sources, and expressing those rules as database joins. In one implementation, joins for disparate tables are inferred using a sequence of priorities with respect to metadata associated with each of the data sources (e.g., database tables). In one implementation, a join mechanism looks for joins in disparate data sources based upon any configured matching columns that are unique keys in a system, such as different identifiers in Microsoft Amalga™.

Further, for each data source, an administrator and/or automated process may specify an arbitrary “tag” for join fields, which provides a way to resolve the difficult task of joining disparate tables for access by a broad category of users. Thus, if the first look (for known matching columns) does not provide an appropriate join, the join mechanism secondarily looks for a matching set of tags between two or more tables to provide the desired join. In the event that the first or second looks fail to provide a meaningful join, the join mechanism allows the user to specify explicit join criteria.

While Microsoft Amalga™ UIS is used as an example herein of a set of data sources in which the join rules may be used, it should be understood that other data sources may benefit from the technology described herein, and that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data processing in general.

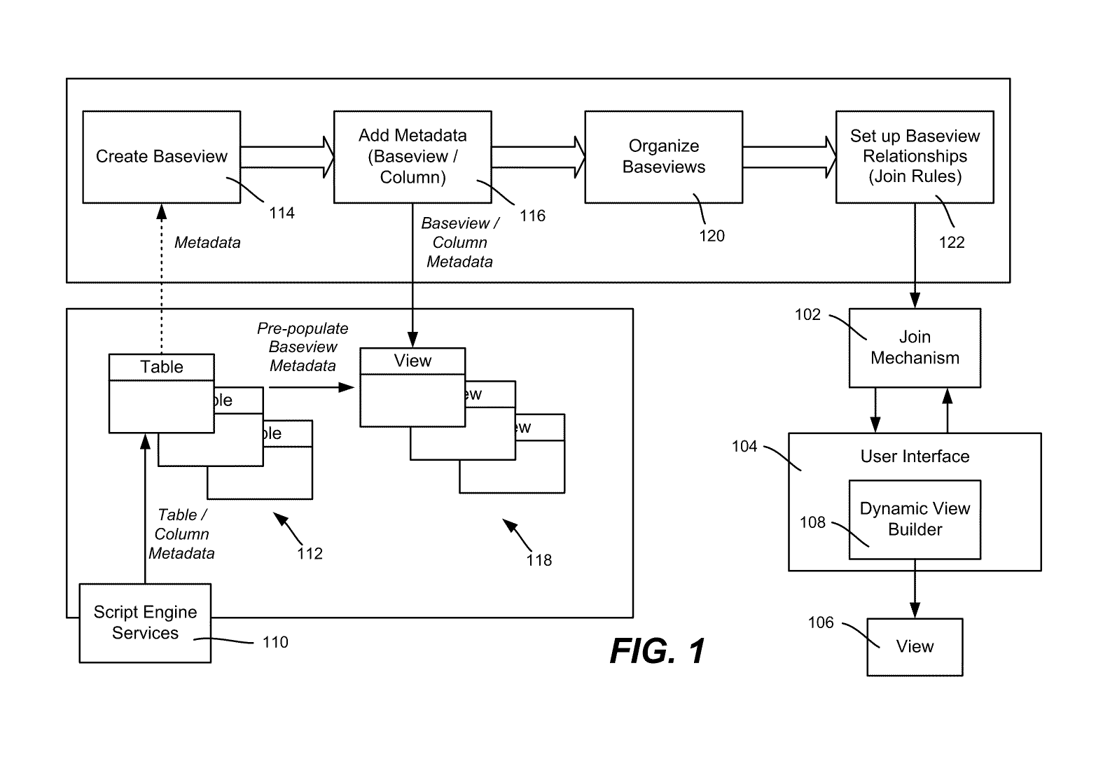

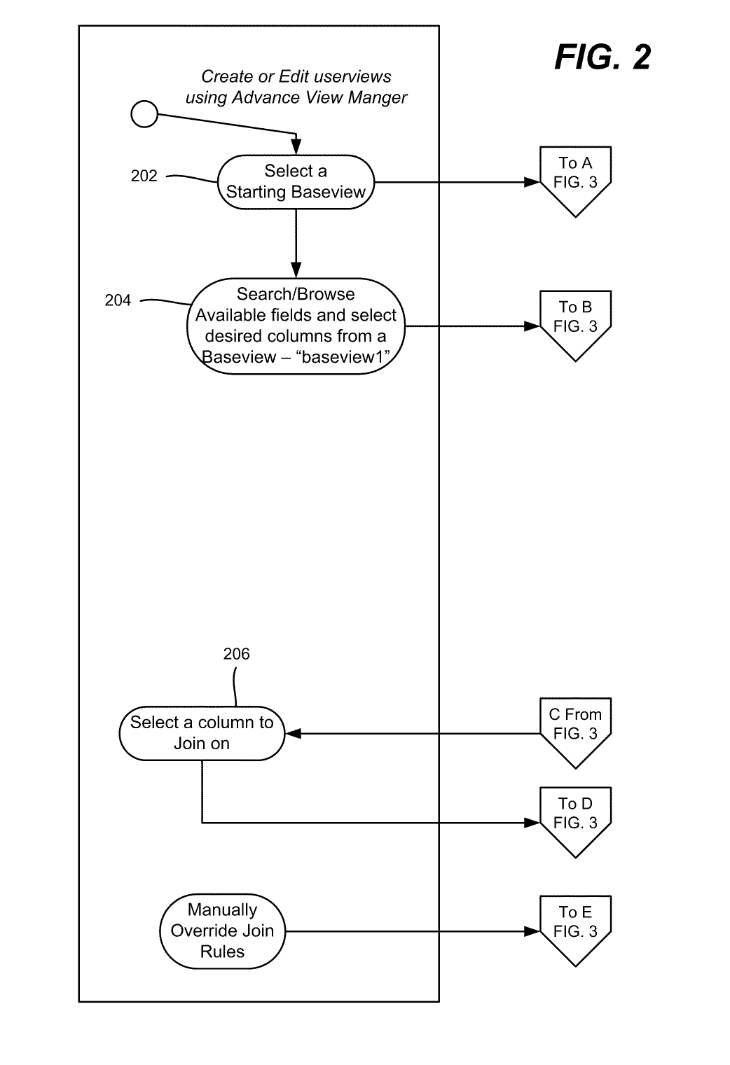

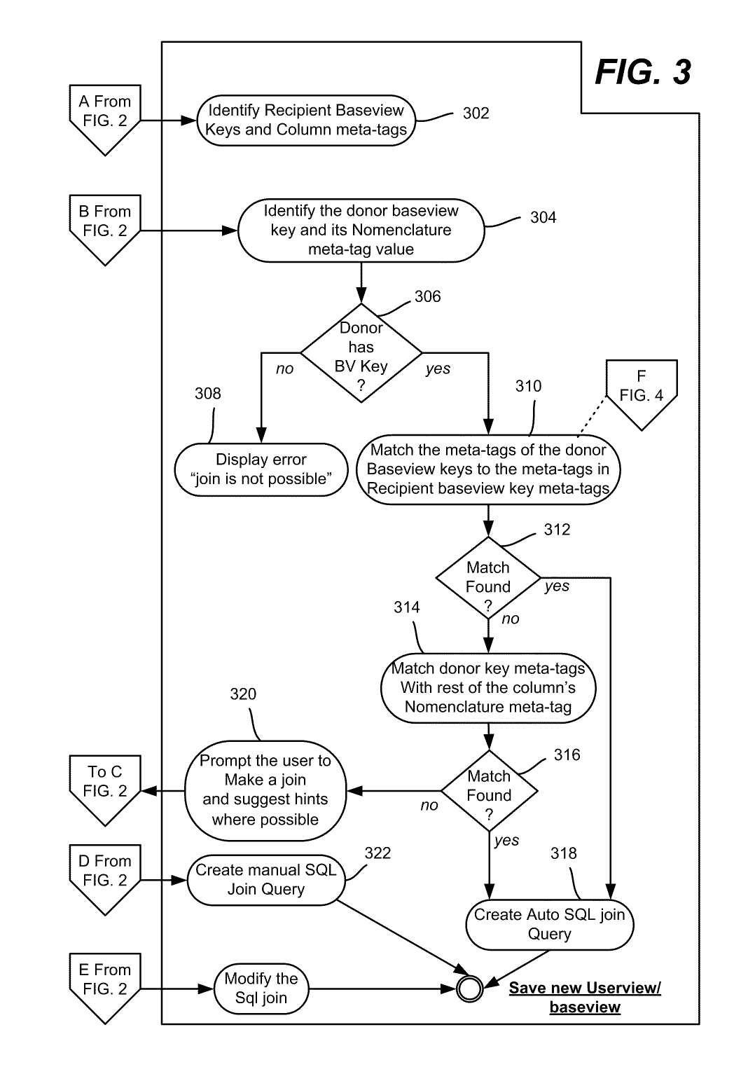

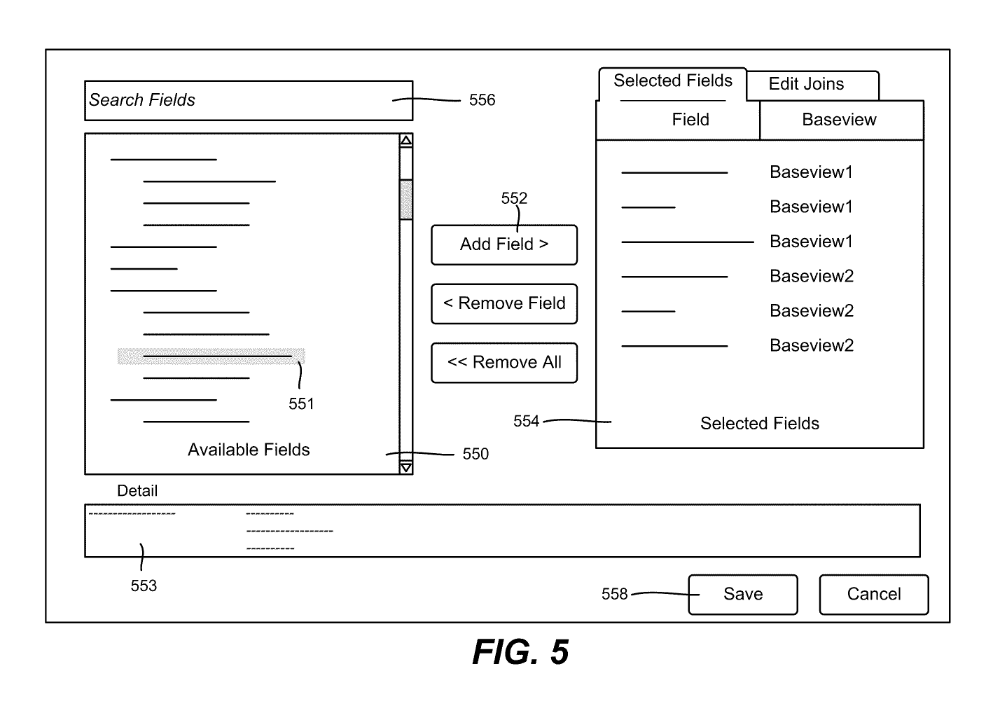

FIG. 1 shows a general architecture for setting up join rules of a join mechanism 102, including logic (FIG. 3) by which a user may interact (FIG. 2) via a user interface 104 to select columns to join from disparate sources (e.g., tables) to provide a desired view 106. For example, a dynamic view builder 108, such as including a user interface screen exemplified in FIG. 5, enables end-users to dynamically create userviews by selecting fields across two or more baseviews. As will be understood, the users may search for or browse the fields they desire, and create a new userview across various baseviews without needing system-administrator intervention. A user also may save a created view, e.g., in a library, where it may be reused and/or shared by other users.

To set up such rules given a script engine services component 110 or the like that provides a number of tables 112, an administrator or the like creates a baseview (block 114) for each table. As described herein, the administrator and/or automated process also associates each baseview with metadata (block 116). For example, the administrator may decide that a patient ID is a suitable unique identifier for each row in a patient table, and thus uses that information as metadata for matching this table with a similar key of another table, as described below.

More particularly, a baseview key comprises a primary key (single or a composite) that defines the uniqueness of a baseview. For example, a baseview key may correspond to one row per patient, one row per visit, one row per lab test (combination of accession ID plus account), or one row per pathologist. Any field or combination of fields that uniquely identifies a row in the baseview may represent the “row atom” for that baseview. Note that there may be more than one field capable of identifying the key in a baseview. By way of example, in a view that has one row per pathologist, a PathologistID field or a PathologistUPIN field, or possibly a PathologistCellPhoneNumber field may be chosen to uniquely identify the row atom.

In addition to a primary key, the administrator and/or an automated process may include tag columns in the table with a nomenclature meta-tag. Note that via the automated process, tags can also be populated by automated methods such as semantic vocabulary scanning, published meta-thesauruses which associate known ontologies to each other, or other automated methods; that is, particular logic may be created such that based on reading the available data or metadata of a particular table or column, additional meta-tags may be generated and annotated to a particular field. A similar meta-tag may be used with other tables that the administrator or the like decides is likely useful to be able to join with the table. For example, in a “procedure” table, the patient ID column may be tagged with a “patient” meta-tag, while a payerID column of a “financial” table may be tagged with a matching “patient” meta-tag. As described below, because both tables have a column tagged with this “patient” meta-tag, a user can join columns from the “procedure” table to columns from the “financial” table to create a view that shows the desired procedure and payment status.

Thus, a nomenclature tag is a global value (within a namespace such as “Amalga” or “Research”) value that provides a matching mechanism. This is a configurable setting that can be updated.

When the baseviews are set up, including with associated metadata, the administrator and/or a process may organize them as desired (block 120), e.g., into groups. The administrator and/or process may also set up relationships between baseviews, e.g., suggestions/hints that an end user can use, as described below. For example, automated processes may reference known or proprietary ontologies, natural language processing engines, or other methods to programmatically create relationships between baseviews.

For example, an administrator may interact to create a new metadata attribute, which can be of type text or multiple choice, with the multiple choice option used to add or edit values for the metadata attribute. The multiple choice metadata attributes present their values as multiple choices nomenclature configuration, showing default metadata attributes configured at the column level. The administrator is able to select one or more default attributes to add to the nomenclature lists, and also may sort the selected nomenclature attributes, which enables the join rules to prioritize the metadata matching

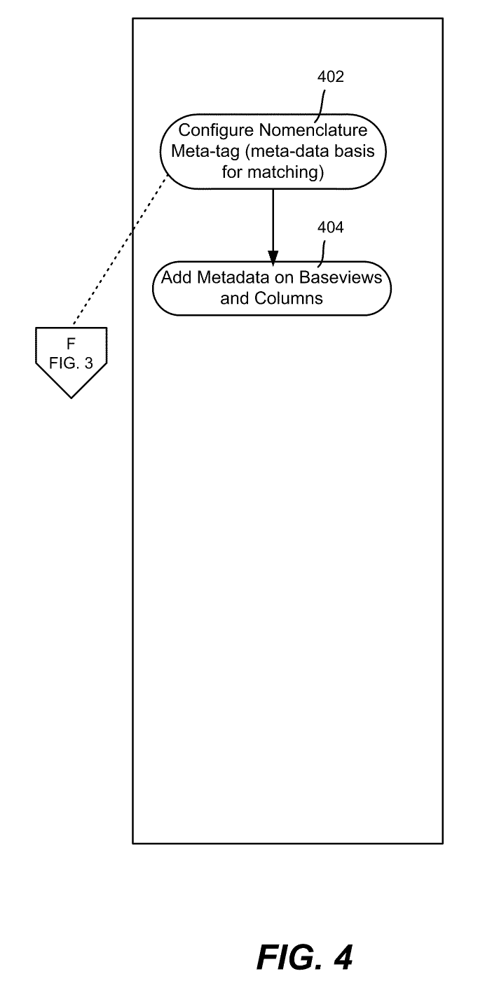

FIGS. 2 to 4 show various aspects in a system flow diagram which is referenced below with reference to a number of scenarios. In general, FIG. 2 represents end user interaction via the user interface 104, FIG. 3 represents the logic of the join rules mechanism 102, and FIG. 4 represents administrator and/or automated process interaction. FIG. 4 has been generally described above, that is, the administrator and/or automated process selects primary keys and configures nomenclature meta-tags as the metadata used as the basis for matching (step 402) and adds the metadata on the baseviews and columns (Step 404).

In general, as represented in FIGS. 2 and 3, the user creates an advance user view by selecting an existing baseview (step 202) as a starting view, for the purpose of adding fields from another baseview. The system identifies the selected baseview's primary key (step 302 of FIG. 3). In general, a starting view is the origin or recipient baseview that the end-user selects first, to which the user may add more columns from different baseviews. An origin baseview is a particular case of a column recipient baseview, (technically, the leftmost baseview in a series of left outer joins that result in a final baseview that has exactly the same rows as the origin baseview). Because only left outer joins are used, the only difference between the origin baseview and the final joined baseview is that the final joined baseview contains more columns.

As generally represented by step 204 of FIG. 2, the user thus selects a baseview, “baseview1” (origin/recipient) to add more columns from different baseviews thereto, e.g., by searching or browsing fields from other baseviews. FIG. 5 shows an example user interface screen in which available fields are shown in a left region 550, e.g., in a tree-like structure. Note that actual field names (in text) appear, however for purposes of simplicity the field names are represented by horizontal lines. Further note that the fields that a user can select may be limited to only those to which the user has access, e.g., a clinician may not be able to see financial data, while a finance department employee is not able to see confidential patient data.

The user can select a field by suitable user interaction (e.g., by moving a highlighted selection box 551), and then click on the “Add Field >” button 552 to add a field to the selected fields region 554 on the right. Note that in one implementation, a user may see a field's related details (module, text description and so forth), e.g., in a detail region 553.

As can be readily appreciated, other ways to find and/or select fields, including by searching (block 556), are feasible. For example, a user may enter a field name in the search field or select an additional flier (metadata attribute) to search the fields in baseviews.

When the user has selected fields from baseview1, the user may also add one or more fields to the selected fields region from another baseview. For example, in FIG. 5, the user has also selected fields from “baseview 2” for obtaining a view; these fields are shown in the region 554 when a join is determined to be possible, as described below.

As represented by step 304 of FIG. 3, the join logic identifies the primary key of the donor baseview (the baseview from which fields are being selected to add to the recipient baseview). If there is no primary baseview (BV) key at step 306, then a join is not possible and the user may be informed (step 306) via an error message or the like displayed to the end-user; one implementation disables the baseview with no primary keys, so user cannot select those columns. More particularly, when the system does not find a baseview key on the donor baseview, the system does not allow the user to add fields from that baseview, thereby preventing the user from adding the columns.

If there is a primary key, step 310 compares the primary key of the donor baseview with the recipient baseview key. If at step 312 the baseview key's meta-tags are the same, then the system automatically joins the baseviews on the baseview key (step 318). At this time, the selected fields region 554 of FIG. 5 is updated with the selected fields from baseview2, e.g., the fields/columns selected from baseview2 appear in the region 554.

If a donor primary key exists but no match is found with the recipient baseview key at step 312, then step 314 compares the donor baseview key's meta-tag with meta-tags of the remaining columns in the recipient baseview, e.g., traversing one at a time to look for a match. If there is a match, the join mechanism branches to step 318 to automatically join the baseviews on the donor baseview key and recipient, and update the selected fields region 554 of FIG. 5 with the selected columns. The system also populates the join rules logic with the matched keys. A scenario in which no match is found at step 316 is described below.

The user may select more columns from the baseview2. The user may then select a save option (button 558), and if so, the system creates SQL joins based on the matching columns. The save may be to a library, to facilitate reuse and/or sharing by other users.

In another scenario, the user adds additional fields from another baseview, “baseview 3” to an existing advance view. To this end, the user may continue to work on the baseview (fields of baseview1 and baseview2) created in the above base flow scenario above. The user may also select a set of columns from baseview3 to add. If so, the system identifies the baseview key met-tag of the donor baseview and then compares it with the baseview key meta-tags of the baseview1 and baseview2. If a match is not found then the system will traverse all the columns (meta-tags) in baseview1 and baseview2 to find a match.

Turning to another scenario, consider that the system is unable to make the automatic join at step 318, that is, no match is found on the baseview key (step 312) or the nomenclature meta-tag (step 316). If so, the user may be provided with a prompt, possibly including hints. This is represented by step 320, which connects to step 206 of FIG. 2 to allow the user to select a column, that is, to add such information, the system suggests that the user make a manual join, whereby the user may manually choose one or more columns to join. The user may be prompted with recommended columns on which the user can choose to join the views.

In another scenario, a user may edit the relationships among the views on which the userview was based. For example, the user may choose to override the baseview matching columns by selecting an override option on an existing advance baseview. The system prompts the user with recommended columns based on the meta-tags, and provides an option to choose any matching column. The user may select a recommended column or any other column to make a join.

A user may also preview the joins that the user creates, e.g., by selecting a preview option. In one implementation, the user is shown some number (e.g., the first twenty-five) results a in a grid like interface. The number of results shown may be user-configurable, and the columns shown may be sortable. Filtering of the results is also provided.

In this manner, administrators and/or an automated process may apply metadata to baseviews/columns and organize baseviews into groups. Users may browse or search for fields, and add them to a custom userview, which is created automatically when possible, based on content meta-tags on baseview columns. If automatic joins are not possible, the system may provide the end-users with recommendations (suggest “join-able” columns), e.g., based on metadata, column names and/or type relationships. Users may accept the recommended matching columns or override the matching column by selecting other columns to form a join.

### Exemplary Operating Environment

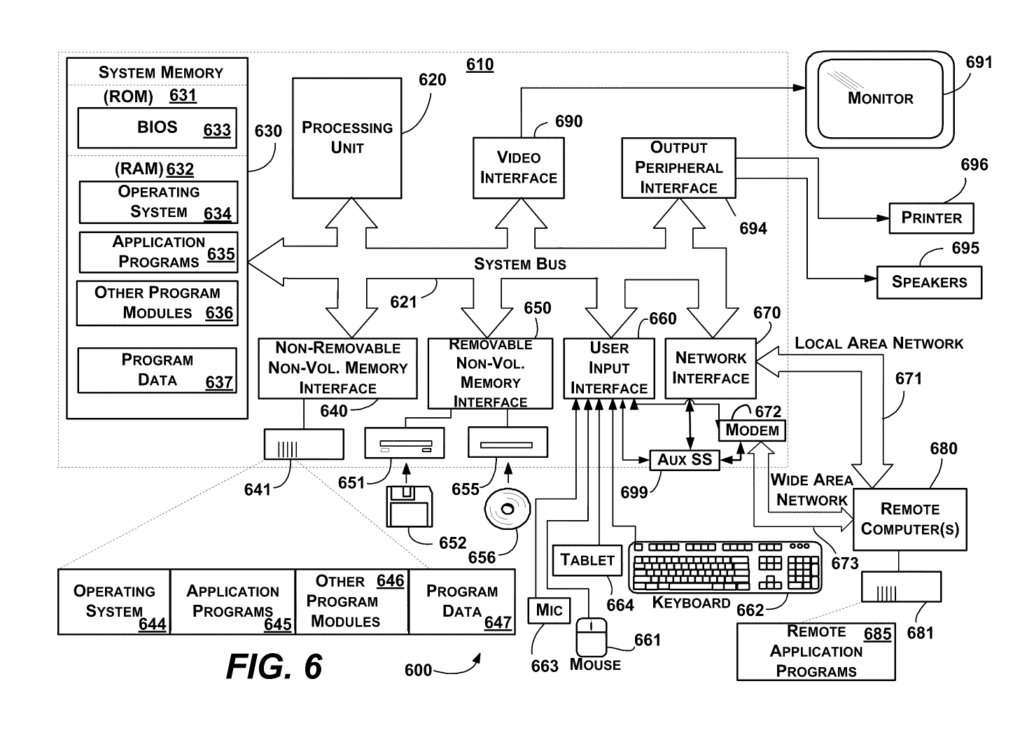

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor, comprising, receiving information that identifies a first data source and a second data source, determining whether metadata associated with the first data source matches metadata associated with the first data source, and if so, joining at least part of the data of the first data source with at least part of the data of the second data source to create a view that shows data from the first and second data sources.

2. The method of claim 1 wherein the first and second data sources correspond to first and second baseviews, and wherein receiving the information that identifies the first data source and the second data source comprise detecting user selection of the first and second baseviews.

3. The method of claim 1 wherein determining whether the metadata associated with the first data source matches the metadata associated with the first data source comprises comparing primary key metadata associated with the first data source against primary key metadata associated with the second data source.

4. The method of claim 1 wherein determining whether the metadata associated with the first data source matches the metadata associated with the first data source comprises, comparing key metadata associated with the first data source against one or more meta-tags associated with the second data source, in which at least some of the meta-tags correspond to table columns of the second data source.

5. The method of claim 1 wherein determining whether the metadata associated with the first data source matches the metadata associated with the first data source comprises comparing primary key metadata associated with the first data source against primary key metadata associated with the second data source, and if no match is determined, secondarily comparing at least one meta-tag associated with the first data source against one or more meta-tags associated with the second data source, in which at least some of the meta-tags correspond to table columns of the second data source.

6. The method of claim 5 wherein the secondarily comparing does not find a match, and further comprising, providing suggested join information for manual user selection of a column.

7. The method of claim 1 further comprising, providing an override mechanism for manual user-selection a column for a join.

8. The method of claim 1 wherein joining at least part of the data of the first data source with at least part of the data of the second data source comprises creating an automatic SQL join query.

9. The method of claim 1 further comprising, receiving information that identifies a third data source, determining whether metadata associated with the third data source matches metadata associated with the first data source or the second data source, and if so, joining at least part of the data of the third data source with the joined data of the first and second data sources to create another view that shows data from the first, second and third data sources.

10. The method of claim 1 further comprising, maintaining the view in a library.

11. In a computing environment, a system comprising:
a user interface, including a mechanism that allows a user to select a first baseview corresponding to a first database table, to add fields corresponding to columns of the first database table to a userview, and to select a second baseview corresponding to a second database table; and
a join mechanism coupled to the user interface, the join mechanism configured to determine whether one or more fields corresponding to one or more columns of the second database table are allowed to be added to the userview based upon first metadata representing join rules associated with the first database table and second metadata representing join rules associated with the second database table.

12. The system of claim 11 wherein the user interface includes a dynamic view builder for adding the fields, including an interactive available fields region that shows fields available for adding by user selection, and a selected fields region that shows any fields that have been selected and added for inclusion in the userview.

13. The system of claim 11 wherein the join mechanism creates the userview when the first metadata matches the second metadata.

14. The system of claim 11 wherein the join mechanism determines whether the one or more fields are allowed to be added to the userview by comparing primary key metadata of the first database table with primary key metadata of the second database table, and allowing the one or more fields to be added if the key metadata matches.

15. The system of claim 11 wherein the join mechanism determines whether the one or more fields are allowed to be added to the userview by comparing at least one meta-tag associated with the first database table with at least one meta-tag associated with the second database table and allowing the one or more fields to be added if a meta-tag matches.

16. The system of claim 11 wherein the join mechanism determines whether the one or more fields are allowed to be added to the userview by comparing primary key metadata of the first database table with primary key metadata of the second database table, and allowing the one or more fields to be added if the key metadata matches, and if the key metadata does not match, by comparing at least one meta-tag associated with the first database table with at least one meta-tag associated with the second database table and allowing the one or more fields to be added if a meta-tag match is detected.

17. The system of claim 11 wherein the join mechanism includes means for providing suggested join information for manual user selection of a column.

18. The system of claim 11 wherein the join mechanism includes an override mechanism for manual user-selection a column for a join.

19. One or more computer-readable media having computer-executable instructions, which when executed perform steps, comprising:
detecting user interaction that identifies columns of a first database table;
accessing first metadata associated with the first database table;
detecting user interaction that identifies columns of a second database table;
accessing second metadata associated with the second database table;
determining whether the first metadata matches the second metadata, and if so, creating a view that presents information from the first database table and the second database table by using a join query.

20. The one or more computer-readable media of claim 19 wherein determining whether the first metadata matches the second metadata comprises comparing primary key metadata of the first database table with primary key metadata of the second database table, and creating a view if the primary key metadata matches, and if the key metadata does not match, by comparing at least one meta-tag associated with the first database table with at least one meta-tag associated with the second database table and creating the view if a meta-tag match is detected.
